(19) United States
(12) Patent Application Publication
(10) Pub. No.: US 2009/0028306 A1
(43) Pub. Date: Jan. 29, 2009

(54) Multimodal network community system for rapid message transmission to multiple specific persons and method of controlling the same

(76) Inventor: Kyung Hoon Rhie, Los Altos, CA (US)

Correspondence Address: Mr. Kyung Hoon Rhie, 417 Becker Lane, Los Altos, CA, 94022, US

(21) Appl. No.: 12/284,078

(22) Filed: Sep. 18, 2008

(30) Foreign Application Priority Data
Mar. 21, 2006 (KR) 10-2006-0025649
Mar. 14, 2007 (KR) PCT/KR2007/001249

(51) Int. Cl. H04M 11/00; G06F 15/16; H04M 1/64; G10L 15/26

(52) U.S. Cl. 379/93.01; 709/206; 704/235; 379/88.04

(57) ABSTRACT

The present invention provides a multimodal network community system capable of transmitting a message to and collecting responses from multiple specific persons in a short period of time and a method of controlling the same, which can transmit a notice (message) to and collect responses from a plurality of members of a specific group or groups in a short period of time according to a predefined procedure via various methods, such as a telephone call, an email, a text message, a web message, an instant message and a voice message, and can collect the results of the recipients' reception of the message and responses via various communication means, automatically arrange them in a database and transmit them to a message transmitter, so that the message transmitter can simultaneously transmit a desired message to a number of persons at one time, the recipients can perfectly receive the message via communication means set by them with a high probability of success and in a timely manner, and a message relay service provider can create a profit-generating business model through sticky and frequent online traffic generated by community and group members, with the result that a number of members can be recruited and retained and the management of members can be facilitated through the application thereof to network community business.

### CROSS REFERENCE TO RELATED APPLICATIONS

This national stage non-provisional application under 35 USC 371 claims the benefit of International Application Number PCT/KR2007/001249, with an international filing date of 14 March, 2007, published in English with an International Publication Date of 4 Oct., 2007.

### BRIEF DESCRIPTION

The present invention relates to a multimodal network community system capable of transmitting a message to and collecting responses from multiple specific persons in a short period of time and to a method of controlling the same.

### BACKGROUND OF THE INVENTION

Existing online network community models aim to be used by individuals for organizing and sharing their information or content related to specific topics. These models employ simple and common operation schemes of transmitting notices and information via message boards, web pages, and blogs or notices via email and text messages.

These models often have shortcomings in that users lose interest over time and the frequency of use rapidly decreases because their content often lacks depth and does not stem from meaningful relationships in the community or group even though their users frequent the websites out of curiosity at the outset.

Meanwhile, there have been development of Information Technology (IT) in such areas as the Internet, technology for converting text into voice or converting voice into text. Using Voice eXtensible Markup Language (VXML), a text message, input via an Internet website, can be converted into voice and then be transmitted. However, the use of such technology has been limited to simple and obvious communication applications, such as voice-recognition-based call centers, computer telephony business or automatic telephony questionnaires.

Meanwhile, when a member of a community or a group needs to communicate a message or a notice to a community or a group, prior art methods employed use of message boards, text messages or email. These methods have problems in that transmitters unilaterally determine methods of communication means regardless of the recipients' particular situations in terms of their ability to access such information. For example, an urgent text message may be sent to recipients even if the recipients may not be able to access it during an overseas vacation, or worse yet, a recipient may have just changed a mobile phone number. If transmitter's best guess for a recipient's effective communication means is mistaken, the recipient cannot receive the message in time to make a time-critical decision—such as participating in an important last minute meeting or selling stock in time before a market crash. In addition, there is no easy way to summarize automatically whether the message has been received by all recipients, and if not, retransmit the message via other means that are more likely to receive a timely attention from the recipients.

As a result, a message transmitter has to contact individually to verify receipt of the message and collect status of message reception and responses. This is an extremely time-consuming and ineffective way to notify an emergency situation or organize an event, especially when time value of the message is high or an event is organized with a short notice.

This has been a common occurrence, when an alumni meeting, a church meeting, a school meeting, or a meeting of a special interest group is held at a short notice.

The object of the present invention is to provide a multimodal network community system capable of transmitting a message to and collecting responses from a single or multiple specific persons in a short period of time and a method of controlling the same, which can transmit a notice (message) to and collect responses from a single or a plurality of members of a specific group in a short period of time based on multimode communication preferences established by recipients such as a combination of telephone call, email, text message, instant message, web message and voice message, and can collect the results of recipients' reception of the message and specific responses via various communication means, automatically arrange them in a database and transmit them to a message transmitter, so that the message transmitter can simultaneously transmit a desired message to a number of persons in a single transmission, the recipients can perfectly receive the message via communication means set by them and controlled by delivery rules of reaching the recipients automatically through multiple communication means until successful reception, and online community service provider can create a profit-generating business model through sticky and frequent online traffic generated by community and group members.

### SUMMARY OF THE INVENTION

The present invention provides a multimodal network community system capable of transmitting a message to and collecting responses from multiple specific persons in a short period of time and a method of controlling the same, which can transmit a notice (message) to and collect responses from a plurality of members of a specific group or groups in a short period of time according to a predefined procedure via various methods, such as a telephone call, an email, a text message, a web message, an instant message and a voice message, and can collect the results of the recipients' reception of the message and responses via various communication means, automatically arrange them in a database and transmit them to a message transmitter, so that the message transmitter can simultaneously transmit a desired message to a number of persons at one time, the recipients can perfectly receive the message via communication means set by them with a high probability of success and in a timely manner, and a message relay service provider can create a profit-generating business model through sticky and frequent online traffic generated by community and group members, with the result that a number of members can be recruited and retained and the management of members can be facilitated through the application thereof to network community business.

In order to accomplish the above object, the present invention provides a multimodal network community system for transmitting a message to and collecting responses from one or multiple specific persons in a short period of time, including wired/wireless terminals used by a message transmitter and one or more message recipients; a connection means for connecting the wired/wireless terminals and a multimodal communication server to each other so as to perform group message transmission and collection of responses; a database for storing information about groups to which the transmitter and the recipients subscribed, information about the recipients' priority message reception communication means, message transmission rules, and schedule information; a multimodal communication server for transmitting a message for group transmission from the transmitter, connected through a wired/wireless terminal, to recipients of a corresponding group via priority communication means set by the recipients, and providing results of reception and responses by the recipients to the transmitter; a control server for performing control such that the transmitter transmits the message sequentially to one communication means at a time; simultaneously to all communication means at one time; and using any message routing method according to the set message rules when the multimodal communication server transmits the message; and a message conversion means for converting a text message into voice data or a voice message into a text message when a communication means of the transmitter is different from a communication means of a recipient.

The present invention has the advantage of providing a multimodal network community system capable of transmitting a message to and collecting responses from one or multiple specific persons in a short period of time and a method of controlling the same, which can transmit a notice (message) to and collect responses from a single or a plurality of members of a specific group in a short period of time according to a predefined procedure via various methods, such as a telephone call, an email, a text message, an instant message, a web message, and a voice message, and can collect the results of recipients' reception of the message and responses via various communication means, automatically arrange them in a database and transmit them to a message transmitter, so that the message transmitter can simultaneously transmit a desired message to a number of persons at one time, the recipients can perfectly receive the message via communication means set by them, and a message relay service provider can create a profit-generating business model through sticky and frequent online traffic generated by community and group members.

### BRIEF DESCRIPTION OF THE DRAWINGS

FIG. 1: is a block diagram of a multimodal network community system according to the present invention.

FIG. 2: is a table showing recipients' message reception communication means, which are stored in a database in the order of priority.

FIG. 3: is a flowchart showing a method of controlling the multimodal network community system according to the present invention.

FIG. 4: is a flowchart showing a procedure in which a transmitter performs group message transmission and collection of responses via a web server according to the present invention.

FIG. 5: is a flowchart showing a procedure in which a transmitter performs group message transmission and collection of responses via an instant message according to the present invention.

FIG. 6: is a diagram showing a group message transmission selection screen that is output to a transmitter's instant message window when the transmitter performs group message transmission using an instant message.

FIG. 7: is a flowchart showing a procedure in which a transmitter performs group message transmission and collection of responses via a mobile phone text message according to the present invention.

FIG. 8: is a flowchart showing a procedure in which a transmitter performs group message transmission and collection of responses via a wired/wireless phone according to the present invention.

### DETAILED DESCRIPTION OF PREFERRED EMBODIMENTS

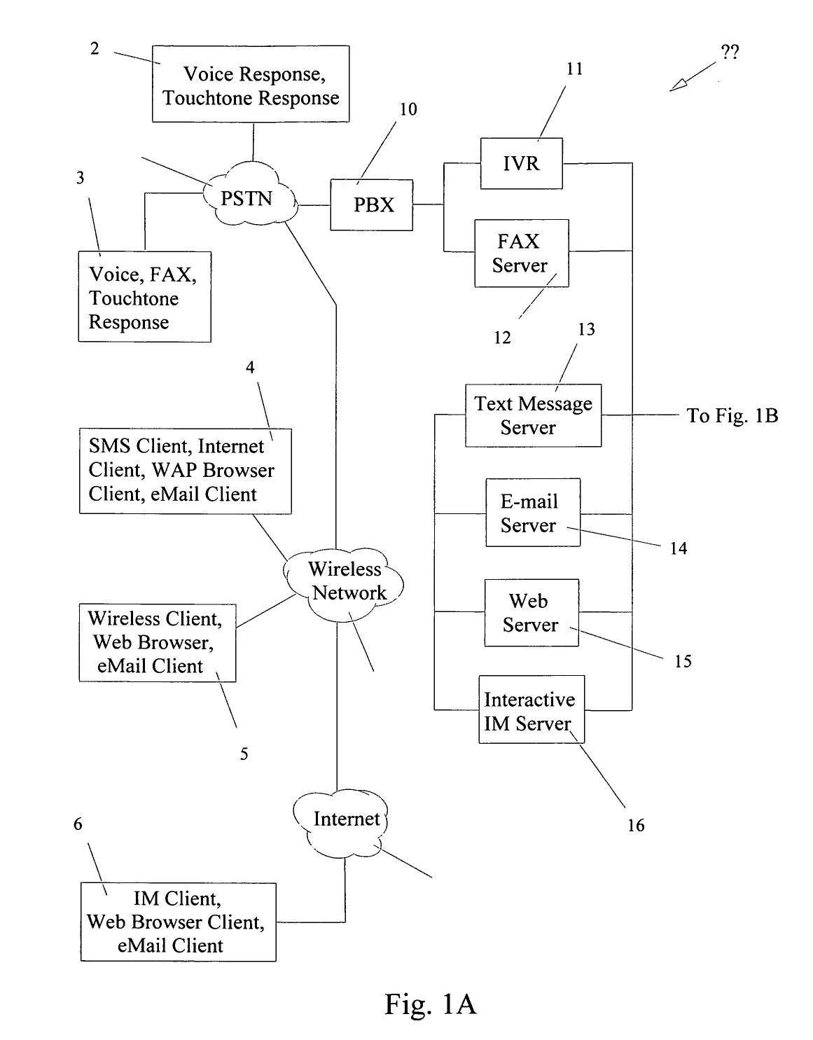

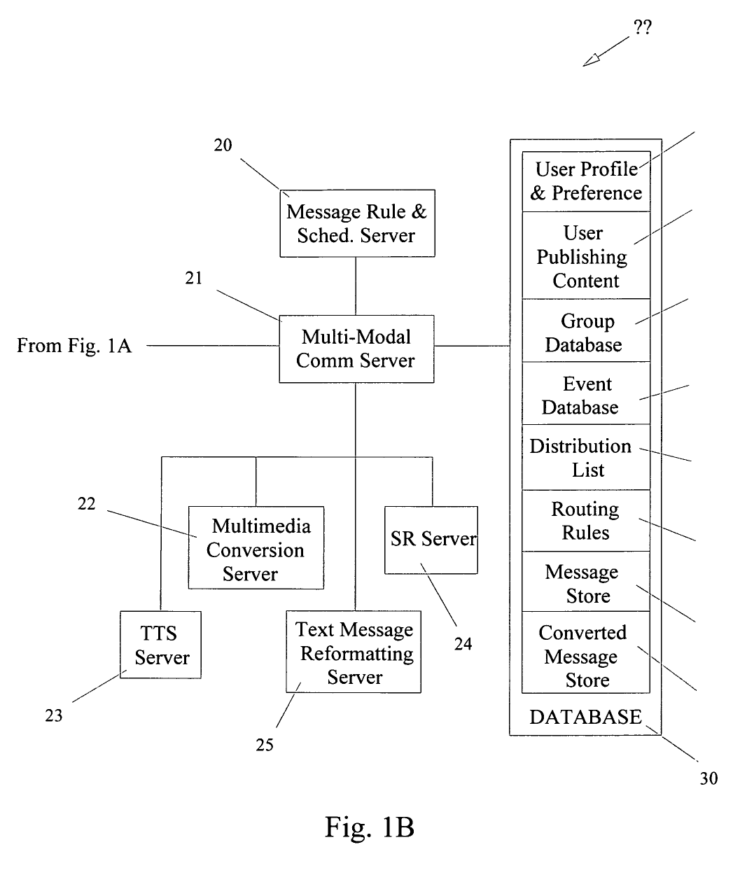

With reference to FIGS. 1 to 8, preferred embodiments of the present invention will be described below.

FIG. 1 is a block diagram showing a multimodal network community system according to the present invention.

The multimodal network community system for transmitting a message to and collecting responses from multiple specific persons in a short period of time, includes:

wired/wireless terminals 1 used by a message transmitter and one or more message recipients;

a connection means for connecting the wired/wireless terminals 1 and a multimodal communication server 21 to each other so as to perform group message transmission and collection of responses;

a database 30 for storing information about groups to which the transmitter and the recipients subscribed, information about the recipients' priority message reception communication means, message transmission rules, and schedule information;

a multimodal communication server 21 for transmitting a message for group transmission from the transmitter, connected through a wired/wireless terminal 1, to recipients of a corresponding group via priority communication means set by the recipients, and providing results of reception and responses by the recipients to the transmitter;

a control server 20 for performing control such that the transmitter transmits the message sequentially to one communication means at a time; simultaneously to all communication means at one time; and using any message routing method according to the set message rules when the multimodal communication server 21 transmits the message; and

a message conversion means for converting a text message into voice data or a voice message into a text message when a communication means of the transmitter is different from a communication means of a recipient.

Each of the wired/wireless terminals 1 is any one of a wired phone 2, capable of transmitting data via a Public Switched Telephone Network (PSTN), a facsimile 3 capable of transmitting and receiving text and graphical images, a mobile phone 4 or a Personal Digital Assistant (PDA) 5 capable of telephone calls and data transmission and reception via a wireless communication network or a wireless Internet, a computer 6, capable of transmitting and receiving data via wired or wireless communication network and the Internet, and some other terminal capable of transmitting and receiving data.

The connection means includes:

an exchange 10 for connecting the wired/wireless terminals 1, an Interactive Voice Response (IVR) 11 and a facsimile server 12 via a PSTN;

the IVR 11 for providing a guide message for selection of group message transmission and collection of responses, input of a message and selection of a group or groups when a wired/wireless terminal 1 makes a connection, storing response information in a database 30 via the multimodal communication server 21, and calling the recipients' telephones and transmitting the transmitter's message in a voice form on group message transmission;

the facsimile server 12 for storing the message for group transmission, received via a facsimile 3, in the database 30, and transmitting the transmitter's transmission message to one or more recipients' facsimiles when the recipients' message reception communication means are facsimiles;

a text message server 13 for transmitting a guide message, guiding the transmitter through selection of a group or groups from a group list and selection of a message transmission time, and inputting a message, to the transmitter's mobile phone 4 when a request for message transmission is made by the transmitter's mobile phone 4, storing response information in the database 30, and transmitting the transmitter's message to one or more recipients' mobile phones in a text message form at a time of group message transmission;

an email server 14 for providing message information to the multimodal communication server 21 and causing the multimodal communication server 21 to interpret the message information when the transmitter makes a request for group transmission via email, storing a message transmission group or groups, storing response information in the database 30, and transmitting the transmitter's transmission message to one or more recipients' email addresses when the one or more recipients' message reception communication means are email;

a web server 15 for providing a guide screen for group message transmission and collection of responses to the transmitter, connected via a wired/wireless terminal 1, storing a message transmission group, message information, a message transmission time, and transmission rules, input via the guide screen, in the database 30, and collecting results of reception of the transmitter's message and responses by the recipients and providing information about the results to the transmitter; and

an instant message server 16 for transmitting prompt data for selection of a message transmission function, input of a message, storing a message transmission group, and selection of a message transmission time when the transmitter makes a connection via an instant message window, storing response information in the database 30, and transmitting the transmitter's transmission message to one or more recipients' instant message windows when the one or more recipients' message reception communication means are instant messages.

The message conversion means includes:

a multimedia conversion server 22 for converting a multimedia file, which is desired to be transmitted by the transmitter, into a file, which can be viewed, read or heard by one or more recipients;

a Text-To-Speech (TTS) server 23 for converting a text transmission message into voice data;

a voice interpretation server 24 for interpreting a voice data transmission message and converting the voice data transmission message into text data; and

a text message reformatting server 25 for removing unnecessary parts from the transmission message received in an email or Short Message Service (SMS) text message form and extracting important parts therefrom.

The recipients assign priorities to communication means for reception of messages and store information about the priorities in the database 30, recipients of a specific group setting and storing first priority communication means, second priority communication means and third priority communication means for reception of messages.

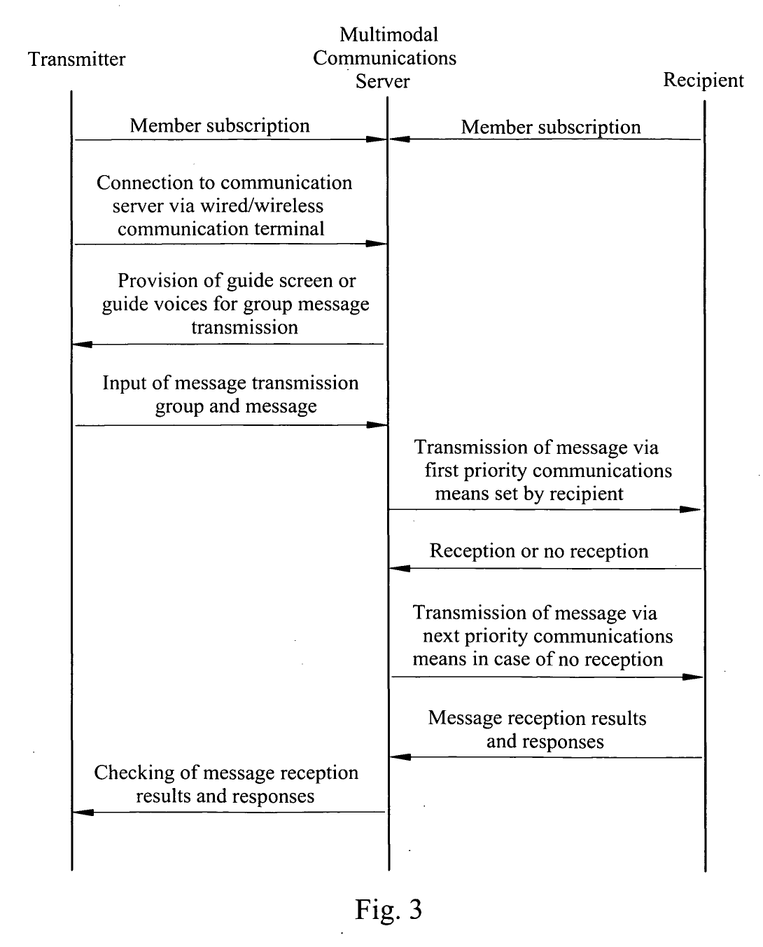

Meanwhile, FIG. 3 shows a control method according to the present invention. The method includes:

a first step of a transmitter and one or more recipients connecting to a multimodal communication server 21, subscribing to the multimodal communication server 21, setting a group to which they pertain, and setting priority communication means for message reception;

a second step of the transmitter connecting to connection means via a wired/wireless terminal 1 and requesting group message transmission;

a third step of the multimodal communication server 21 transmitting a message to recipients of a group or groups selected by the transmitter, the multimodal communication server 21 transmitting the message via respective communication means for respective recipients simultaneously or in order of priority previously set by the recipients; and

a fourth step of providing information about status of the recipients' message reception and responses to the transmitter.

At the first step, each of the recipients selects a plurality of communication means, capable of receiving messages, from a telephone call, a facsimile, a text message, an email, a web message and an instant message simultaneously or in order of priority and stores information about the communication means in the database 30.

At the second step, when the transmitter requests group message transmission, the multimodal communication server 21 transmits guide information that guides the transmitter through selection of a group or groups from among groups with which the transmitter has a relationship, guide information that guides the transmitter through input of a message to be transmitted, and guide information that guides the transmitter through setting of transmission rules to the wired/wireless terminals 1.

At the third step, the multimodal communication server 21 transmits simultaneously or first transmits the transmitter's message via first priority communication means set by the recipients, sequentially transmitting the transmitter's message via second and third priority communication means if one or more recipients do not receive the message for a predetermined period of time, collects results of the recipients' message reception and responses, and stores the results in the database 30.

At the third step, the multimodal communication server 21 converts and transmits the transmitter's message via message conversion means if the transmitter's message form is different from a recipient's reception message form at a time of transmission of the transmitter's message via the communication means set by the recipient.

The conversion of the message is performed by converting text into voice information via a TTS server 23 and then transmitting the voice information via one or more telephones or voice messages if the transmitter's message is text, and by converting a voice message into a text message via a voice interpretation server 24 and then transmitting the text message via one or more emails, text messages, web messages, and/or instant messages if the transmitter's message is a voice message.

The operation of the present invention, constructed as described above, will be described through various embodiments based on the transmission means of a transmitter.

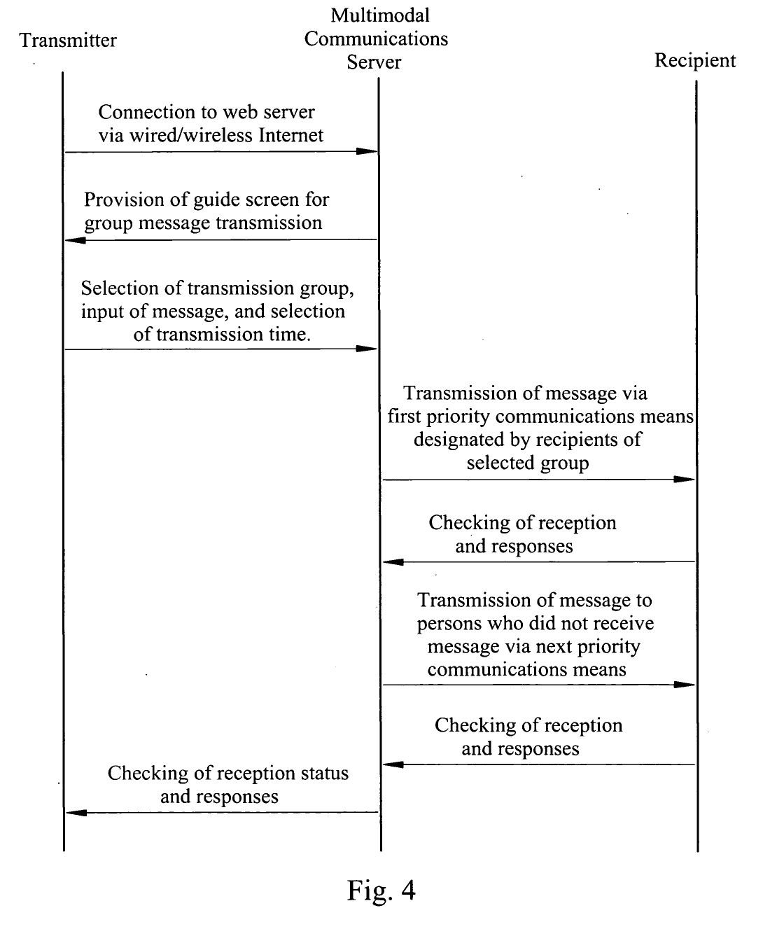

The first embodiment relates to a method in which a transmitter transmits a message via an Internet website, as shown in FIG. 4.

First, the transmitter connects to a web server 15 via the Internet using a computer 6, and the web server 15 performs an authentication procedure using an IDentifiction (ID) and a password input by the transmitter, and then provides a guide screen for group message transmission to the transmitter's computer 6.

The guide screen is configured such that the transmitter can select a desired group or groups from among groups with which the transmitter has a relationship, input a message to be transmitted, and select a message transmission time and rules required for the transmission of the message.

That is, the transmitter, via the guide screen provided by the web server 15, selects the group or groups to which a message will be transmitted, and inputs a message transmission time, rules required for the transmission of the message, and the message to be transmitted.

With regard to the rules required for the transmission of a message, a message transmitter can set specific conditional routing rules such as a rule that triggers transmission of the message to one or multiple specific recipients if a result of message reception or response of another recipient meets a specific criteria, and a rule that causes a message to be simultaneously or sequentially transmitted, based on meeting of a condition, to a plurality of recipients.

The message, the transmission group, the transmission rules, and the transmission time, which are input by the transmitter as described above, are stored in a database 30.

Thereafter, the control server 20 commands a multimodal communication server 21 to transmit the transmitter's message when the transmission time stored in the database 30 has been reached, and the multimodal communication server 21 retrieves a list of recipients, to which the message will be transmitted, from the database 30, and controls a connection means such that the message can be transmitted via communication means that belong to message reception communication means previously set by the recipients and that have first priority or all communication means simultaneously if so previously set by the recipients.

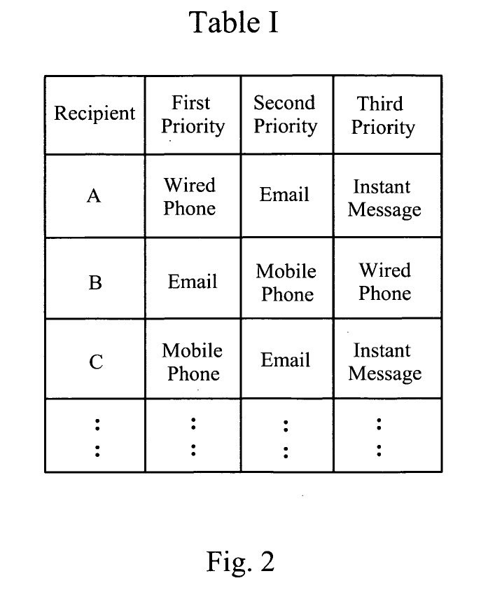

For example, as shown in FIG. 2, when a message is desired to be transmitted to three recipients A, B, and C, the transmission message is provided to an IVR 11 and an email server 14 because recipients A, B and C set a wired phone, email and a mobile phone, respectively, as first priority communication means.

In this case, the message transmitted to the IVR 11 is converted into voice data and supplied by a TTS server 23, and the IVR 11 transmits the transmitter's message to recipients A and C's wired phone and mobile phone in the form of a voice signal.

Meanwhile, the email server 14 transmits the transmitter's message to recipient B's email address.

In addition, in the case where a recipient has set an instant message as the highest-priority message reception communication means, an instant message is sent to the recipient's computer, which is connecting to the Internet, via an instant message server 16, and the recipient receives the transmitter's message via an instant message window that is displayed on the screen of the computer 6.

Meanwhile, in the case where a recipient has selected a mobile phone text message as the highest-priority message reception communication means, the transmitter's message is transmitted to the recipient's mobile phone via a text message server 13 in the form of an SMS text message.

Meanwhile, in the case where the recipient has not received the transmission message for a predetermined period of time when the message is transmitted via the first communication means, the multimodal communication server 21 transmits the transmitter's message to the recipient sequentially via the second and the third priority communication means. Alternatively, the transmission message may also be transmitted simultaneously to all priority communication means. The results of the recipient's message reception and responses based on all message transmissions are collected and stored in the database 30.

The results of the recipient's message reception and responses are stored in the database 30, and the transmitter can check the results of all recipients' message reception and responses stored in the database 30 at one time while connecting to the web server 15.

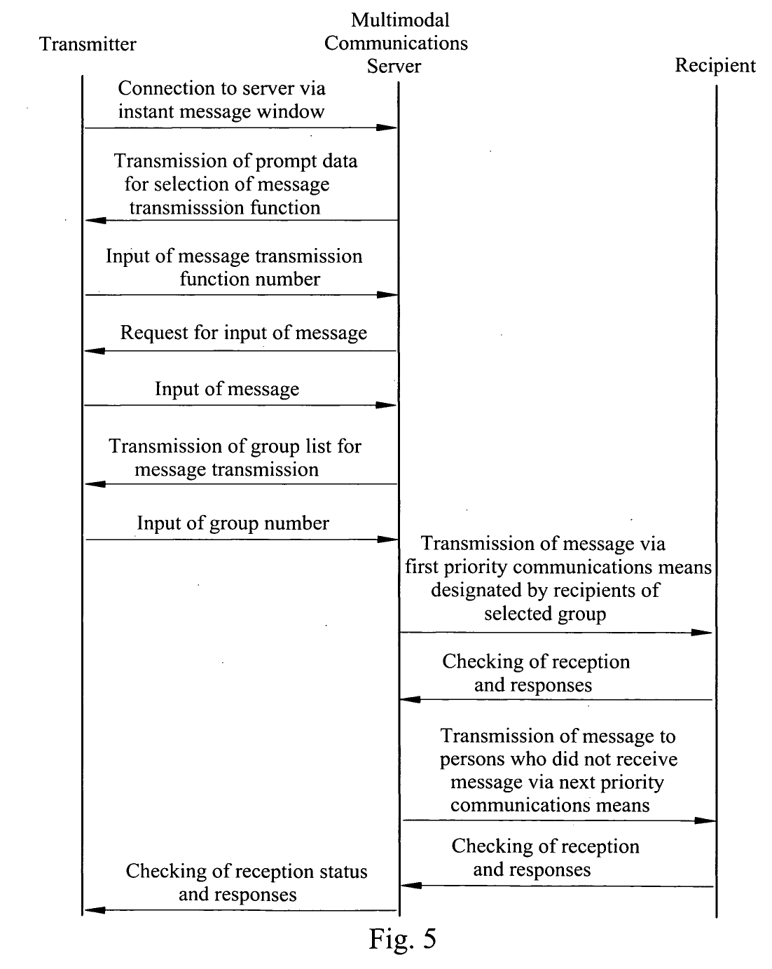

The second embodiment illustrates a procedure in which a transmitter transmits a transmission message via the instant messaging functionality (MSN messenger, Google messenger, Yahoo messenger, AOL instant messenger, Daum Messenger, or the like) of the computer 6, as illustrated in FIG. 5.

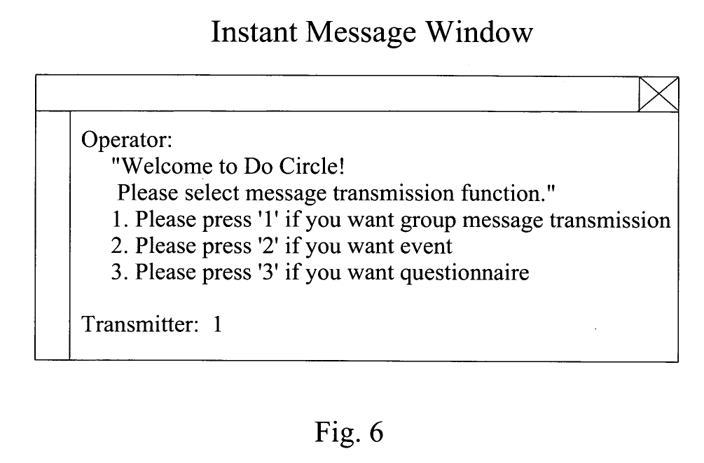

First, a user connects to an instant message server 16 via the instant message window of the computer 6, and the instant message server 16 transmits an ID number and function selection prompt data, that is, prompt data that allows the user to select group message transmission, as shown in FIG. 6, to the transmitter's instant message window.

When the transmitter selects group message transmission by entering “1” in response to the prompt data, the instant message server 16 transmits data, requesting the input of a message to be transmitted, to the instant message window. Thereafter, when the transmitter enters the message to be transmitted in the instant message window in response to the request data, the instant message server 16 transmits a list of groups, to which the message will be transmitted, to the transmitter.

The group list is a list of groups with which the transmitter has a relationship, such as 1. UCLA KSA group, 2. BMW group, and 3. LA gamer group. The transmitter selects one or more from among the groups by entering the number(s) of the group to which the message is desired to be transmitted.

Additionally, the instant message server 16 causes the transmitter to enter the time of the transmission of the message by requesting that the transmitter enter the time at which the message will be transmitted.

After the transmitter has entered the message to be transmitted, the group or groups to which the message will be transmitted, and the transmission time while the transmitter and the instant message server 16 exchange messages via the instant message window, the corresponding information is stored in the database 30.

Thereafter, the multimodal communication server 21 transmits the message to all communication means simultaneously or first priority communication means previously set by respective recipients at the message transmission time, as in the above-described first embodiment, and collects the results of the transmission and notifies the transmitter of the results of the transmission including status of message reception and responses.

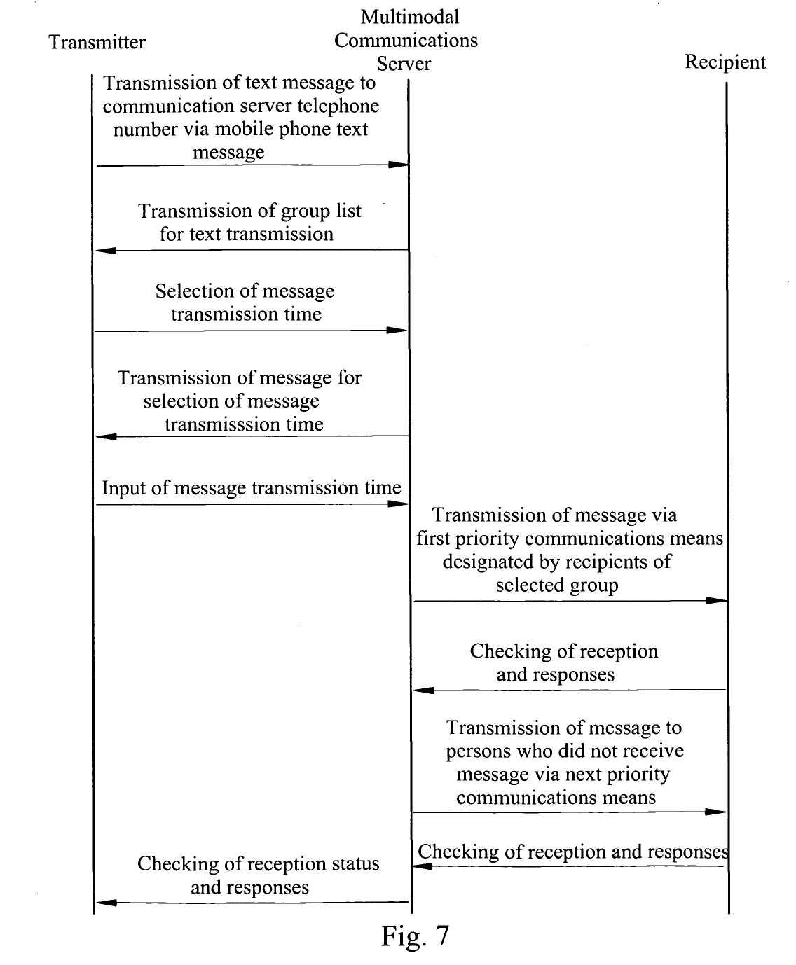

The third embodiment illustrates a procedure in which a transmitter transmits a transmission message using a mobile phone text message, as illustrated in FIG. 7.

First, the transmitter transmits the text message “message” to the telephone number of the text message server 13 using his or her own mobile phone 4, and the text message server 13 becomes aware that the current transmitter desires to transmit a message in a group transmission fashion based on the received text message.

In this case, the text message server 13 authenticates membership by comparing the caller identification number of the text message, sent by the transmitter, with members' mobile phone telephone numbers, stored in the database 30.

Thereafter, the text message server 13 transmits a list of groups, with which the transmitter has a relationship, to the transmitter's mobile phone 4 in the form of a text message such as “1. UCLA KSA group, 2. BMW group, and 3. LA gamer group,” and the transmitter transmits a text message to the text message server 13, with the number of a group or the numbers of groups, which is selected from the received group list and to which the message is desired to be transmitted, entered in the text message.

In a similar manner, the text message server 13 transmits a text message prompting for message content and the message transmission time to the transmitter's mobile phone 4, the transmitter transmits a text message, in which message content and the message transmission time have been entered in response to the prompts from the text message server 13, to the text message server 13, and the text message server 13 stores information about the message content that is desired to be transmitted by the transmitter, the recipient group or groups, and the message transmission time in the database 30 based on the text message received from the transmitter.

Thereafter, when the message transmission time has been reached, the multimodal communication server 21 transmits the message to recipients' all communication means simultaneously or the first priority communication means under the control of the control server 20 in the above-described manner, and transmits the second and the third messages if a recipient does not receive the first message via the first priority communication means, so that the recipient can perfectly receive the message.

Furthermore, the recipients' reception results and responses are collected, are stored in the database 30 and are reported to the transmitter, so the transmitter can conveniently transmit and track a desired message to a plurality of recipients.

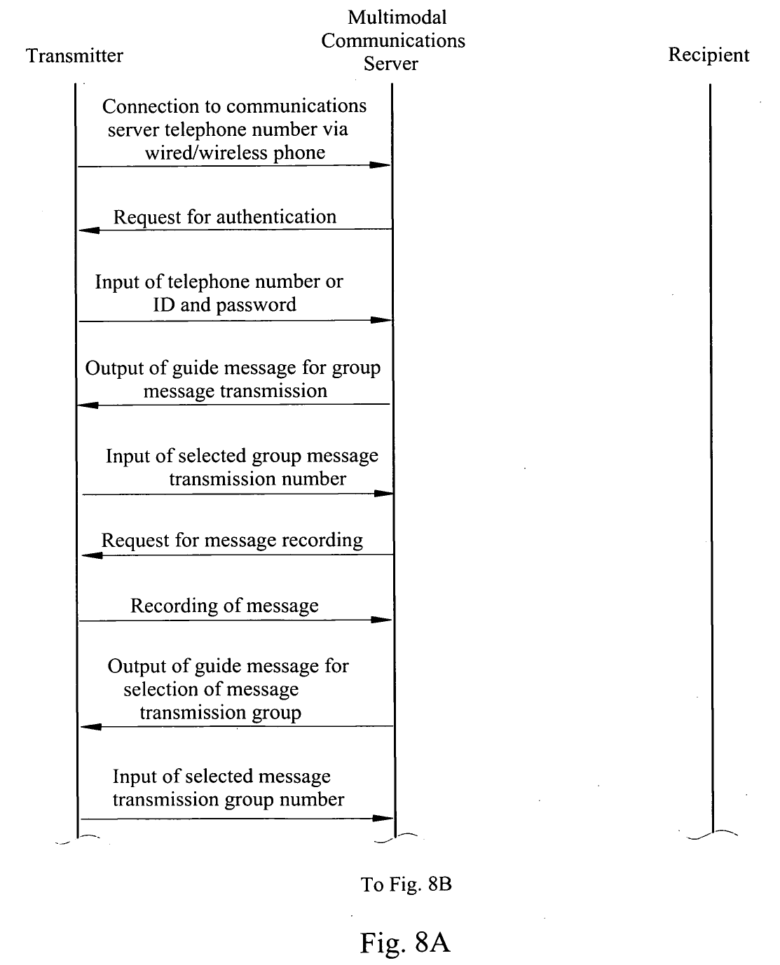

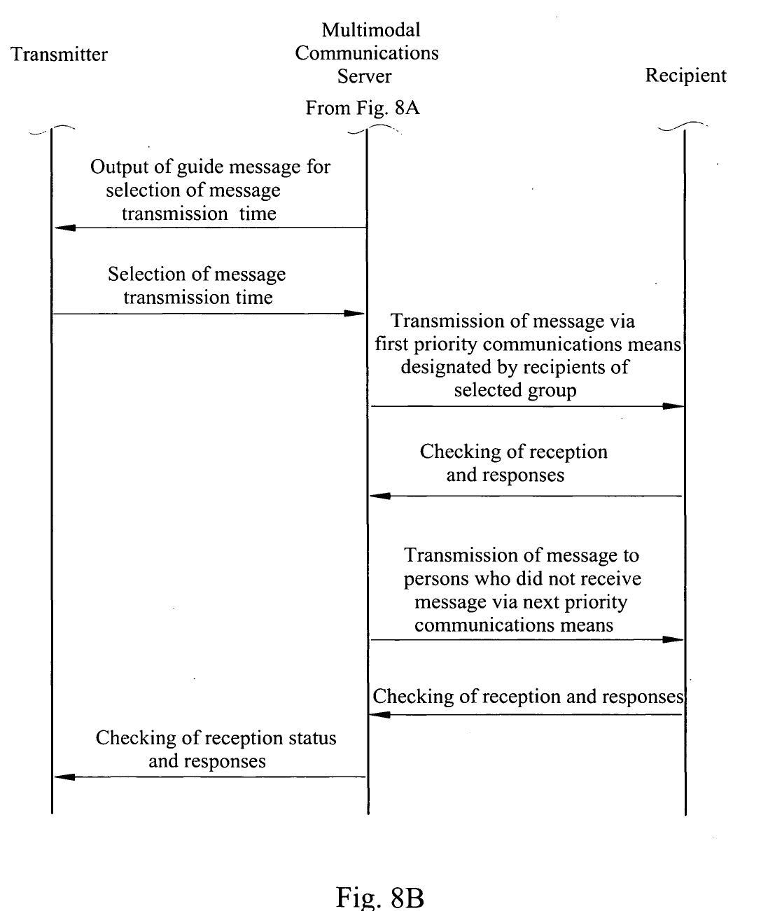

The fourth embodiment illustrates a procedure of transmitting a message using a wired/wireless phone, as illustrated in FIG. 8.

First, a transmitter connects to the telephone number of the IVR 11 using a wired/wireless phone (phone 2 or mobile phone 4), and the IVR 11 issues a voice guide message, requesting authentication, to the transmitter's wired/wireless phone.

When the transmitter enters a telephone number or ID and a password, which were entered at the time of subscription for membership, in response to the voice guide message, the IVR 11 authenticates the transmitter and then prompts the transmitter to select a function using a voice prompt, giving instructions on how to reply with use of touchtone or voice responses.

The prompt is transmitted in the form of the voice instruction “Hello! Mr. or Ms. OOO. Welcome to DoCircle! Please enter a number corresponding to one of the following functions and press “#.”

1. please press ‘1’ if you want group message transmission, 2. please press ‘2’ if you want an event, and 3. please press ‘3’ if you want a questionnaire,” and the transmitter selects message transmission by pressing ‘1’ in response to the voice prompt.

When the message transmission is selected by the transmitter, the IVR 11 requests the recording of a message to be transmitted to the recipient. Thereafter, when the transmitter records the message to be transmitted to the recipient in response to the request, the IVR 11 stores the recording data in the database 30.

Furthermore, the IVR 11 announces groups with which the transmitter has a relationship via a voice prompt so that the transmitter can select a group or groups, and transmits a voice guide message, guiding the transmitter through the selection of a transmission time, when the transmitter has selected the group or groups to which the message will be transmitted in response to the guidance.

When the transmitter enters the message that will be transmitted via a telephone call in the form of voice, the message transmission group, and the transmission time in the above-described procedure, the multimodal communication server 21 transmits the message to the recipients of the group, selected by the transmitter, using a method identical to the above-described method when the message transmission time has been reached.

In this case, when the recipients wish to receive the message in the form of a text message, a web message, an instant message and an email message, the audio message information, recorded by the transmitter, is interpreted and converted into a text message by the voice interpretation server 24, and is transmitted to the recipients via the text message server 13, the email server 14, the web server 15, and the instant message server 16.

Meanwhile, in the present invention, the transmitter may transmit a transmission message to a facsimile server 12 using a facsimile 3, and may transmit a transmission message to the multimodal communication server 21 using the email server 14 in the form of an email, in addition to the means that have been described in the previous embodiments.

According to the present invention, operated as described above, the following advantages can be expected.

First, since multiple recipients previously register communication means capable of desirably receiving messages and a message is transmitted via the communication means sequentially or simultaneously, preset by the recipients, at the time of transmission of the message, the message reception success rate and timeliness of reception can be increased substantially.

Second, since messages are transmitted via designated communication means, reception of the messages by recipients can be accurately checked, and can be reported back to the transmitter.

Third, a message can be transmitted to all members at one time through a request for the transmission of the message even if the contact addresses of the members of a group with which the transmitter has a relationship are not personally known, and recipients can receive messages from the members of a group without disclosing private communication information, such as a telephone number or an email address.

Fourth, since conditional message routing rules can be set, message reception by a specific recipient or a specific response by a specific recipient such as Yes or No can cause to transmit a message to another recipient after reception of the message by the first recipient. For example, an invitation message for a meeting can be conditionally routed to a specific person based on the attendance information of another person or availability of a venue.

Fifth, since message transmitters and the recipients of each group can check the members' reception of messages and responses thereto in near real-time, reactions thereto can be made. That is, a member of a group, who becomes aware that there is a problem with a place proposed by a transmitter, can issue a warning to all of the members who have received the message, or can propose another place.

Sixth, since recipients can change the priority of communication means regardless of time and place, message reception success rates can be further increased.

Seventh, automation of message transmission, response collection, and summarization of all messages saves significant amount of time and energy by all parties involved.

What is claimed is:

1. A multimodal network community system for transmitting a message to and collecting responses from a single or multiple specific persons in a short period of time, comprising:
wired/wireless terminals (1) used by a message transmitter and one or more message recipients;
connection means for connecting the wired/wireless terminals (I) and a multimodal communication server (21) to each other so as to perform group message transmission and collection of responses;
a database (30) for storing information about groups to which the transmitter and the recipients subscribed, information about the recipients' priority message reception communication means, message transmission rules, schedule information and transmission messages;
a multimodal communication server (21) for transmitting a message for group transmission from the transmitter, connected through a wired/wireless terminal (1), to recipients of a corresponding group or groups via priority communication means set by the recipients, and providing results of reception and responses by the recipients to the transmitter; and
a control server (20) for performing control such that the transmitter sequentially or simultaneously transmits the message according to the set message rules when the multimodal communication server (21) transmits the message.

2. The multimodal network community system as set forth in claim 1, further comprising message conversion means for converting a text message into voice data or a voice message into a text message when a communication means of the transmitter is different from a communication means of a recipient.

3. The multimodal network community system as set forth in claim 1, wherein each of the wired/wireless terminals (1) is any one of a wired phone (2), capable of transmitting data via a Public Switched Telephone Network (PSTN), a facsimile (3) capable of transmitting and receiving text and graphical images, a mobile phone (4) or a Personal Digital Assistant (PDA) (5) capable of telephone calls and data transmission and reception via a wireless communication network or a wireless Internet, a computer (6), capable of transmitting and receiving data via a wired or wireless communication network or the Internet, and some other terminal capable of transmitting and receiving data.

4. The multimodal network community system as set forth in claim 1, wherein the connection means comprises:
an exchange (10) for connecting the wired/wireless terminals (1), an Interactive Voice Response (IVR) (11) and a facsimile server (12) via a PSTN;
the IVR (11) for providing a guide message for selection of group message transmission and collection of responses, input of a message and selection of a group or groups when a wired/wireless terminal (1) makes a connection, storing response information in a database (30) via the multimodal communication server (21), and calling one or more of the recipients' telephones and transmitting the transmitter's message in a voice form on group message transmission and collecting responses;
the facsimile server (12) for storing the message for group transmission, received via a facsimile (3), in the database (30), and transmitting the transmitter's transmission message to one or more recipients' facsimiles when the recipients' message reception communication means are facsimiles;
a text message server (13) for transmitting a guide message, guiding the transmitter through selection of a group or groups from a group list and selection of a message transmission time, to the transmitter's mobile phone (4) when a request for message transmission is made by the transmitter's mobile phone (4), storing response information in the database (30), and transmitting the transmitter's message to one or more recipients' mobile phones in a text message form at a time of group message transmission;
an email server (14) for providing message information to the multimodal communication server (21) and causing the multimodal communication server (21) to interpret the message information when the transmitter makes a request for group transmission via email, and transmitting the transmitter's transmission message to one or more recipients' email addresses when the one or more recipients' message reception communication means are email;
a web server (15) for providing a guide screen for group message transmission to the transmitter, connected via a wired/wireless terminal (1), storing a message transmission group or groups, message information, a message transmission time, and transmission rules, input via the guide screen, in the database (30), and collecting results of reception of the transmitter's message and responses by one or more of the recipients and providing information about the results to the transmitter; and
an instant message server (16) for transmitting prompt data for selection of a message transmission function, input of a message, setting of transmission rules, and selection of a message transmission time when the transmitter makes a connection via an instant message window, storing response information in the database (30), and transmitting the transmitter's transmission message to one or more recipients' instant message windows when the one or more recipients' message reception communication means are instant messages.

5. The multimodal network community system as set forth in claim 2, wherein the message conversion means comprises:
a multimedia conversion server (22) for converting a multimedia file, which is desired to be transmitted by the transmitter, into a file, which can be viewed by one or more recipients;
a Text-To-Speech (TTS) server (23) for converting a text transmission message into voice data;
a voice interpretation server (24) for interpreting a voice data transmission message and converting the voice data transmission message into text data; and
a text message reformatting server (25) for removing unnecessary parts from the transmission message received in an email, an instant message, a Short Message Service (SMS) text message, or some other data-type message form and extracting important parts therefrom.

6. The multimodal network community system as set forth in claim 1, wherein the recipients assign simultaneous or sequential priorities to communication means for reception of messages and store information about the priorities in the database 30, recipients of a specific group setting and storing the first priority communication means, the second priority communication means and the third priority communication means for reception of messages.

7. A method of controlling a multimodal network community system for transmitting a message to and collecting responses from multiple specific persons in a short period of time, comprising:
a first step of a transmitter and one or more recipients connecting to a multimodal communication server (21), subscribing to the multimodal communication server (21), setting a group or groups to which they pertain, and setting priority communication means for message reception;
a second step of the transmitter connecting to connection means via a wired/wireless terminal (1), setting message routing methods rules, and requesting group message transmission;
a third step of the multimodal communication server (21) transmitting a message to recipients of a group or groups selected by the transmitter, the multimodal communication server (21) transmitting the message via respective communication means for respective recipients simultaneously or in order of priority previously set by the recipients; and
a fourth step of providing information about status of the recipients' message reception and collection of responses to the transmitter.

8. The method as set forth in claim 7, wherein, at the first step, each of the recipients selects a plurality of communication means, capable of receiving messages, from a telephone call, a facsimile, a text message, a web message, an email, and an instant message simultaneously or in order of priority and stores information about the communication means in the database 30.

9. The method as set forth in claim 7, wherein, at the second step, when the transmitter requests group message transmission, the multimodal communication server 21 transmits guide information that guides the transmitter through selection of a group or groups from among groups with which the transmitter has a relationship, guide information that guides the transmitter through input of a message to be transmitted, guide information that guides the transmitter through setting of transmission rules to the wired/wireless terminals (1), and guide information that guides the transmitter through collection of status information about the recipients' message reception and responses.

10. The method as set forth in claim 7, wherein, at the third step, the multimodal communication server (21) transmits simultaneously or first transmits the transmitter's message via first priority communication means set by the recipients, sequentially transmitting the transmitter's message via second and third priority communication means if one or more recipients do not receive the message for a predetermined period of time, collects results of the recipients' message reception and responses, and stores the results in the database (30).

11. The method as set forth in claim 7, wherein, at the third step, the multimodal communication server 21 converts and transmits the transmitter's message via message conversion means if the transmitter's message form is different from a recipient's reception message form at a time of transmission of the transmitter's message via the communication means set by the recipient.

12. The method as set forth in claim 11, wherein the conversion of the message is performed by converting text into voice information via a TTS server (23) and then transmitting the voice information via telephones or voice messages if the transmitter's message is text, and by converting a voice message into a text message via a voice interpretation server (24) and then transmitting the text message via email, text messages, web messages, and/or instant messages if the transmitter's message is a voice message.

13. The method as set forth in claim 7, wherein the wired/wireless terminal (1) is any one of a wired phone (2) capable of transmitting data via a PSTN, a facsimile (3) capable of transmitting and receiving text and graphical images, a mobile phone (4) or a Personal Digital Assistant (PDA) (5) capable of telephone calls and data transmission and reception via a wireless communication network or a wireless Internet, a computer (6) capable of transmitting and receiving data via wired and wireless communication network or the Internet, and some other terminal capable of transmitting and receiving data.

14. The method as set forth in claim 9, wherein the transmitter can designate a specific person of a group for transmission of a message when setting the group to which the message will be transmitted.

15. The method as set forth in claim 7, wherein, at the fourth step, the multimodal communication server (21) collects the recipient's reception status and responses, stores information about the status in the database (30), and allows the transmitter to view the status and response information or transmits the collected recipients' reception status and response information to the transmitter's wired/wireless terminal (1).
